(19) United States
(12) Patent Application Publication
(10) Pub. No.: US 2026/0336469 A1
(43) Pub. Date: Oct. 29, 2026

(54) BATTERY MANAGEMENT APPARATUS AND METHOD

(71) Applicants: HYUNDAI MOTOR COMPANY, Seoul (KR); KIA CORPORATION, Seoul (KR)

(72) Inventors: Sang Jin Lee, Hwaseong-si (KR); Ju Seok Kim, Hwaseong-si (KR); Ji Eun Hwang, Hwaseong-si (KR)

(73) Assignees: HYUNDAI MOTOR COMPANY, Seoul (KR); KIA CORPORATION, Seoul (KR)

(21) Appl. No.: 19/394,630

(22) Filed: Nov. 19, 2025

(30) Foreign Application Priority Data
Apr. 28, 2025 (KR) 10-2025-0055686

(51) Int. Cl. B60L 58/13; H01M 10/42

(52) U.S. Cl. CPC B60L 58/13; H01M 10/425; B60L 2260/52; H01M 2010/4271; H01M 2010/4278

(57) ABSTRACT

A battery management apparatus includes a memory and a processor. The processor is configured to store battery usage history information based on battery monitoring information of a battery in a vehicle. The processor is also configured to determine a battery usage pattern based on the battery usage history information. The processor is further configured to determine a user-adaptive battery charge range based on the battery usage pattern. The processor is additionally configured to control charging of the battery based on the user-adaptive battery charge range.

### CROSS-REFERENCE TO RELATED APPLICATION

This application claims the benefit of and priority to Korean Patent Application No. 10-2025-0055686, filed on Apr. 28, 2025, the entire contents of which are hereby incorporated herein by reference.

### TECHNICAL FIELD

The present disclosure relates to a battery management apparatus and method.

### BACKGROUND

Electric vehicles are typically equipped with batteries that may provide energy or power for driving of the vehicle. The battery may deteriorate in performance, may decrease in life, or may cause a safety accident due to several factors, such as a charge and discharge count, a change in battery temperature, a charge voltage, over-charging and over-discharging, and an external temperature.

The matters described in this Background section are provided merely to enhance understanding of the background of the present disclosure and should not be construed as being included in the related art known to those having ordinary skill in the art.

### SUMMARY

The present disclosure has been made to solve the above-mentioned problems occurring in the prior art while advantages achieved by the prior art are maintained intact.

Aspects of the present disclosure provide an apparatus and method for managing a battery in an optimal state with regard to factors that may affect performance, life, and safety of the battery. In at least some aspects, the apparatus and method may prevent the deterioration in battery performance, the decrease in battery life, and the battery safety accident.

Aspects of the present disclosure provide a battery management apparatus and method for analyzing a battery usage pattern and controlling battery charging based on the analyzed battery usage pattern.

Aspects of the present disclosure provide a battery management apparatus and method for analyzing a battery usage pattern of a user and adjusting a maximum amount of charge of a battery based on the analyzed battery usage pattern of the user.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a battery management apparatus is provided. The battery management apparatus includes a memory and a processor. The processor is configured to store battery usage history information based on battery monitoring information of a battery in a vehicle. The processor is also configured to determine a battery usage pattern based on the battery usage history information. The processor is additionally configured to determine a user-adaptive battery charge range based on the battery usage pattern. The processor is further configured to control charging of the battery based on the user-adaptive battery charge range.

The processor may be configured to accumulate and store used energy for each predetermined remaining battery capacity and temperature interval based on the battery usage history information.

The processor may be configured to determine an average discharge speed based on the battery usage history information.

The processor may be configured to determine average used energy based on the battery usage history information.

The processor may be configured to determine destination-based energy required to reach a destination set in a navigation device, based on a route to the destination set in the navigation device.

The processor may be configured to compare the average used energy with the destination-based energy and may determine a maximum amount of charge within the user-adaptive battery charge range by adding the average used energy to minimum remaining energy of the battery, based on determining that the average used energy is greater than the destination-based energy.

The processor may be configured to determine a maximum amount of charge within the user-adaptive battery charge range by adding the destination-based energy to the minimum remaining energy of the battery, based on determining that the average used energy is not greater than the destination-based energy.

The processor may be configured to transmit the battery monitoring information to an external electronic device using a communication circuit.

The external electronic device may be configured to generate and store battery usage history information associated with a user based on the battery monitoring information. The external electronic device may also be configured to analyze a battery usage pattern for the user based on the battery usage history information associated with the user.

The processor may be configured to receive the battery usage pattern for the user via the communication circuit and set the user-adaptive battery charge range based on the battery usage pattern received for the user via the communication circuit.

According to another aspect of the present disclosure, a battery management method is provided. The battery management method includes storing battery usage history information based on battery monitoring information of a battery in a vehicle. The battery management method also includes determining a battery usage pattern based on the battery usage history information. The battery management method additionally includes determining a user-adaptive battery charge range based on the battery usage pattern. The battery management method further includes controlling charging of the battery based on the user-adaptive battery charge range.

Storing the battery usage history information may include accumulating and storing used energy for each predetermined remaining battery capacity and temperature interval based on the battery usage history information.

Determining the battery usage pattern may include determining an average discharge speed based on the battery usage history information.

Determining the battery usage pattern may include determining average used energy based on the battery usage history information.

Determining the user-adaptive battery charge range may include determining destination-based energy required to reach a destination set in a navigation device, based on a route to the destination set in the navigation device, and comparing the average used energy with the destination-based energy.

Determining the user-adaptive battery charge range may include determining a maximum amount of charge within the user-adaptive battery charge range by adding the average used energy to minimum remaining energy of the battery, based on determining that the average used energy is greater than the destination-based energy.

Determining the user-adaptive battery charge range may include determining a maximum amount of charge within the user-adaptive battery charge range by adding the destination-based energy to minimum remaining energy of the battery, based on determining that the average used energy is not greater than the destination-based energy.

Storing the battery usage history information may include transmitting the battery monitoring information to an external electronic device using a communication circuit and generating and storing, by the external electronic device, battery usage history information associated with a user based on the battery monitoring information.

Determining the battery usage pattern may include analyzing a battery usage pattern for the user based on the battery usage history information associated with the user.

Determining the user-adaptive battery charge range may include receiving the battery usage pattern for the user from the external electronic device and setting the user-adaptive battery charge range based on the battery usage pattern received for the user from the external electronic device.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a battery management apparatus according to an embodiment of the present disclosure;

FIG. 2 is a graph illustrating data in which a usage time for each SOC and temperature is accumulated according to an embodiment of the present disclosure;

FIG. 3 is a graph illustrating data in which used energy for each SOC and temperature is accumulated according to an embodiment of the present disclosure;

FIG. 4 illustrates an example of setting a user-adaptive battery charge range according to an embodiment of the present disclosure;

FIG. 5 is a flowchart illustrating a battery management method according to an embodiment of the present disclosure;

FIG. 6 is a block diagram illustrating a battery management apparatus according to another embodiment of the present disclosure; and

FIG. 7 is a flowchart illustrating a battery management method according to another embodiment of the present disclosure.

### DETAILED DESCRIPTION

Hereinafter, embodiments of the present disclosure are described in detail with reference to the accompanying drawings. In adding the reference numerals to the components of the drawings, it should be noted that the identical components are designated by the identical numerals even when the components are displayed on different drawings. Further, in describing the embodiment of the present disclosure, where it was determined that a detailed description of well-known features or functions would obscure the gist of the present disclosure, the detailed description thereof has been omitted.

In describing components of embodiments of the present disclosure, terms such as first, second, A, B, (a), (b), and the like may be used herein. These terms are merely used to distinguish one component from another component. These terms do not limit the corresponding components irrespective of the order or priority of the corresponding components. Furthermore, unless otherwise defined herein, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present disclosure.

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus. The one or more processors may be configured to implement computer-readable instructions stored in the memory to perform the described operations.

A state of charge (SOC) is an index indicating the remaining capacity (or the remaining energy) of a battery. SOC may be represented as a percentage (%) obtained by dividing a currently useable battery capacity by a full capacity. A charging range may be set to control charging and discharging, when the battery is charged. A maximum amount of charge (or a maximum SOC) of the battery within the charging range may be defined as a SOC upper limit and a minimum amount of charge (or a minimum SOC) of the battery may be defined as a SOC lower limit.

A user SOC (USOC) may be defined as an index indicating the remaining battery capacity set for each user (or each battery owner). A user-adaptive battery charge range may be set with regard to a battery usage pattern of the user. A maximum amount of charge of the battery in the user-adaptive battery charge range may be a SOC upper limit corresponding to a USOC of 100% and may be defined as a USOC upper limit. A minimum amount of charge of the battery may be a SOC lower limit corresponding to a USOC of 0% and may be defined as a USOC lower limit.

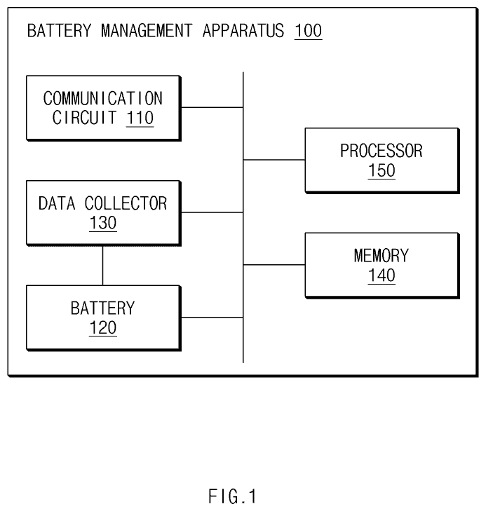

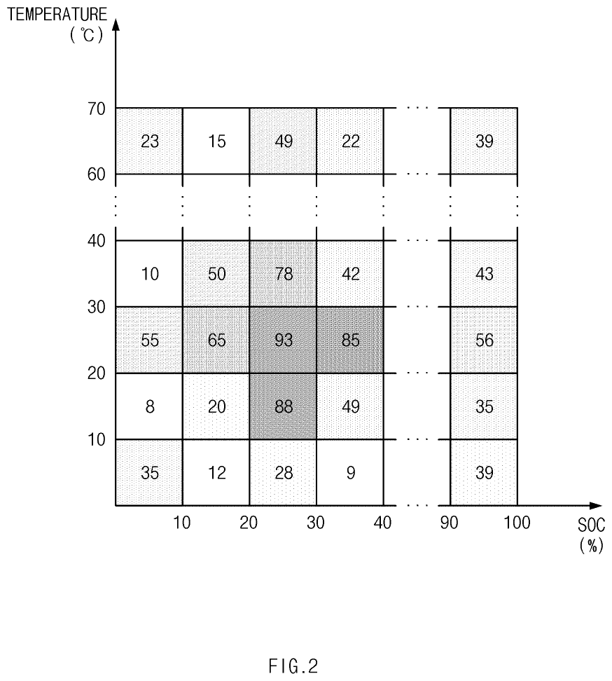

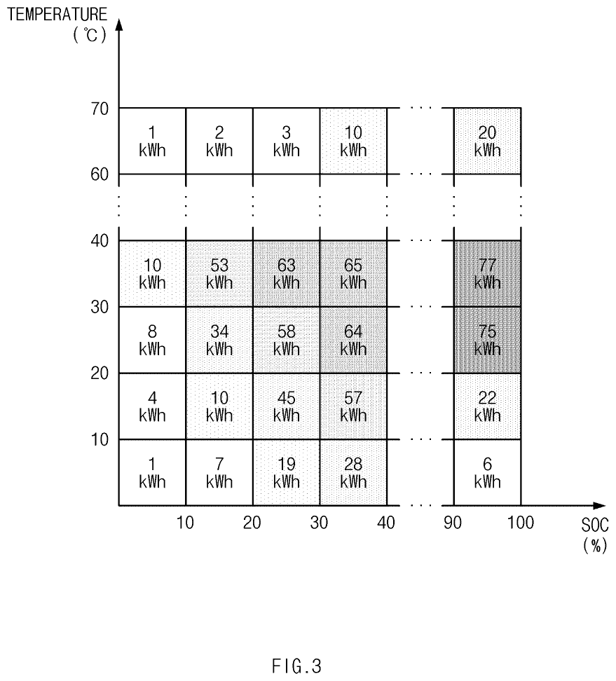

FIG. 1 is a block diagram illustrating a battery management apparatus according to an embodiment of the present disclosure. FIG. 2 is a graph illustrating data in which a usage time for each SOC and temperature is accumulated according to an embodiment of the present disclosure. FIG. 3 is a graph illustrating data in which used energy for each SOC and temperature is accumulated according to an embodiment of the present disclosure.

A battery management apparatus 100 may be implemented inside or outside a vehicle. The battery management apparatus 100 may play a role in managing life, performance, and safety of a battery 120. Referring to FIG. 1, the battery management apparatus 100 may include a communication circuit 110, a data collector 130, a memory 140, a processor 150, and/or the like. The battery management apparatus 100 may also include, or may be coupled to, the battery 120. The communication circuit 110, the data collector 130, the memory 140, the processor 150, the battery 120 and/or the like may be connected with each other via a communication bus.

The communication circuit 110 may support at least one of wired communication or wireless communication, or any combination thereof between the battery management apparatus 100 and an external device. The communication circuit 110 may include at least one of a wireless communication circuit or a wired communication circuit, or any combination thereof.

The battery 120 may be an energy storage device for storing electric energy. The battery 120 may include or be composed of a cell, which is the smallest basic unit, a module including a plurality (e.g., a predetermined number) of cells, and/or a pack including a plurality (e.g., a predetermined number) of modules. The battery 120 may include any one of energy storage devices, such as a lithium-ion (Li-ion) battery, a lithium-ion (Li-ion) polymer battery, a lead-acid battery, a nickel-cadmium (NiCd) battery, and/or a nickel-hydride (NiMH) battery.

The battery 120 may supply electric energy (or power) to an electrical device loaded into the vehicle, for example, the battery management apparatus 100, an electronic control unit (ECU), a navigation device (not shown), a drive motor (or a power source), or the like. The battery 120 may supply electric energy to the drive motor in an electric vehicle (EV) mode or a hybrid electric vehicle (HEV) mode. The battery 120 may be changed with electric energy (or regenerative energy) generated by the drive motor in a regenerative breaking mode. The battery 120 may be charged by electric energy supplied from the outside (e.g., a charging facility or the like) via a charging interface.

The data collector 130 may collect battery state information using sensors installed in the battery 120. The sensors may include at least one of a voltage sensor, a current sensor, a temperature sensor, or any combination thereof. The battery state information may include at least one of a voltage of the battery 120, a current of the battery 120, a temperature of the battery 120, or any combination thereof.

The data collector 130 may collect information (or data) from an electronic device (e.g., a charging and discharging control device, the ECU, the navigation device, or the like) installed in the vehicle. The data collector 130 may collect battery monitoring information using the sensor, the electronic device, and/or the like. The battery monitoring information may include battery state information, a battery SOC, a battery USOC, a charging start time, a charging end time, used energy (or discharge energy), a charging start SOC, a charging end SOC, a charging start USOC, a charging end USOC, a usage time (or a discharge time), and/or the like.

The memory 140 may be a non-transitory storage medium that stores instructions executed by the processor 150. The memory 140 may include at least one of a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), an embedded multimedia card (eMMC), web storage, or any combination thereof.

At least one of an algorithm for measuring a voltage, a current, a temperature, or the like, a SOC computation algorithm, a state of health (SOH) estimation algorithm, a cell balancing algorithm, a thermal management algorithm, a diagnostic algorithm, or a protection algorithm, or any combination thereof may be stored in the memory 140.

Battery information, battery monitoring information, and/or charge and discharge control information (or charge/discharge control information) may be stored in the memory 140. The battery information may include a rated capacity, a useable capacity, a rated voltage, and/or the like. The charge/discharge control information may include a SOC upper limit, a SOC lower limit, a USOC upper limit, a USOC lower limit, a charge speed, a discharge speed, and/or the like. The SOC upper limit and the USOC upper limit may be used as criteria for determining complete battery charge (or full battery charge). The SOC lower limit and the USOC lower limit may be the minimum remaining energy, which may be used as criteria for determining complete battery discharge.

Battery usage history information based on battery monitoring information may be stored in the memory 140. The battery usage history information may include battery usage time information and/or battery energy usage information. The battery usage time information may be information associated with calendar aging over time, which may be a time (or a battery unused time) that has an influence on battery aging (or degradation) while the battery is not in use. As shown in FIG. 2, the battery usage time information may include a battery unused time accumulated for each predetermined SOC and temperature interval of the battery 120 (or an accumulated battery unused time). The battery unused time may be defined as a time difference from an ignition-off (or stop) time point from an ignition-on (or start) time point. The battery energy usage information may be information associated with cycle aging according to charging and discharging of the battery 120. Referring to FIG. 3, the battery energy usage information may include an amount of used energy obtained by accumulating energy used during charging or while driving for each predetermined SOC and temperature interval of the battery 120 (or accumulated battery used energy). The battery energy usage information may include an accumulated driving time and an average battery voltage.

The processor 150 may control the overall operation of the battery management apparatus 100. The processor 150 may include at least one of an application specific integrated circuit (ASIC), a digital signal processor (DSP), a programmable logic device (PLD), a field programmable gate array (FPGA), a central processing unit (CPU), a microcontroller, or a microprocessor, or any combination thereof. In FIG. 1, the processor 150 is illustrated including one processor, but not limited thereto. The processor 150 may include two or more processors.

The processor 150 may collect the battery monitoring information using the data collector 130. The processor 150 may generate battery energy information based on the battery state information collected by the data collector 130. For example, the processor 150 may calculate or otherwise determine a battery SOC using the battery voltage measured by the data collector 130. The processor 150 may generate and store battery usage history information in the memory 140 based on the battery monitoring information collected by the data collector 130.

The processor 150 may analyze a battery usage pattern of a user based on the battery usage history information stored in the memory 140. The processor 150 may calculate or otherwise determine an average discharge speed of the battery 120 using the battery usage history information. The average discharge speed may be represented as an average discharge current rate (C-rate). The C-rate is a value obtained by dividing a charge current or a discharge current by a rated capacity [Ah] of the battery 120. The abbreviation C of ‘Capacity’ is used as a unit of C-rate.

The processor 150 may calculate or otherwise determine the average discharge speed of the battery 120 based on accumulated used energy [kWh], an accumulated driving time [h], and an average battery voltage in the battery usage history information.

The processor 150 may calculate or otherwise determine average used energy based on battery energy usage information in the battery usage history information. The average used energy may refer to the average amount of electric energy used up to next charging after charging. In other words, the average used energy may be defined as an average amount of electric energy used on one charge.

Furthermore, the processor 150 may calculate or otherwise determine average used energy using the average discharge speed.

The processor 150 may calculate or otherwise determine destination-based required energy based on the battery usage history information. When a destination is set in the navigation device (not shown), the processor 150 may receive predetermined starting point information and the set destination information from the navigation device. The processor 150 may calculate or otherwise determine an amount of electric energy required to reach the destination with regard to a route from the predetermined starting point to the set destination, i.e., destination-based required energy. When calculating or otherwise determining the destination-based required energy, the processor 150 may use an average discharge speed.

The processor 150 may set a battery charge range of the user, i.e., a user-adaptive battery charge range, based on the average used energy and the destination-based required energy. The processor 150 may determine a larger value between the average used energy and the destination-based required energy as an amount of charged energy. The processor 150 may determine a maximum amount of charge (or a user-adaptive maximum amount of charge or a USOC upper limit) in the user-adaptive battery charge range based on the determined amount of charged energy. A minimum amount of charge (or a user-adaptive minimum amount of charge or a USOC lower limit) in the user-adaptive battery charge range may be determined as minimum remaining energy (e.g., a USOC of 0%).

The processor 150 may control charging of the battery 220 based on the determined user-adaptive battery charge range. For example, the processor 150 may, when the battery 120 is being charged, determine the battery 120 to be fully charged when the charge of the battery 120 reaches the USOC upper limit determined based on the average discharge speed and/or the average used energy. As another example, the processor 120 may provide an indication that the battery 120 should be charged when the battery 120 reaches the USOC lower limit.

The processor 150 may compare the average used energy with the destination-based required energy to determine whether the average used energy is greater than the destination-based required energy. When it is determined that the average used energy is greater than the destination-based required energy, the processor 150 may determine a USOC upper limit based on the average used energy. For example, the processor 150 may add the average used energy to the minimum remaining energy to determine the USOC upper limit. When it is determined that the average used energy is not greater than the destination-based required energy, the processor 150 may determine a USOC upper limit based on the destination-based required energy. For example, the processor 150 may add the destination-based required energy to the minimum remaining energy to determine the USOC upper limit.

When the average used energy is the same as the destination-based required energy, the processor 150 may add the average used energy or the destination-based required energy to the minimum remaining energy to determine a USOC upper limit.

The processor 150 may use the determined USOC upper limit as criteria for determining whether the battery 120 is fully charged. The processor 150 may determine whether the battery SOC reaches the determined USOC upper limit upon charging. When it is determined that the battery SOC reaches the determined USOC upper limit, the processor 150 may output a notification or an indication indicating that the battery charging is completed (or a USOC of 100%) to an output device (not shown). The output device may include at least one of a display, a light emitting diode (LED), a cluster, or a speaker, or any combination thereof.

The processor 150 may determine whether the battery SOC reaches a USOC lower limit. When it is determined that the battery SOC reaches the USOC lower limit, the processor 150 may output a notification or an indication indicating that the battery charging is required (or an indication of a USOC being 0%). The processor 150 may output a notification or an indication indicating a USOC corresponding to the battery SOC to the output device.

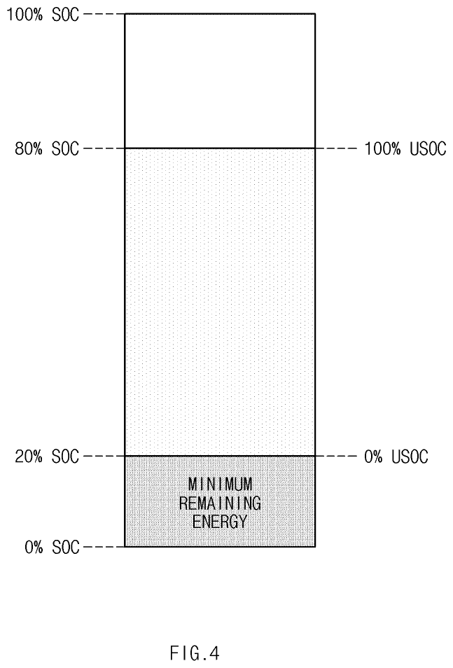

FIG. 4 illustrates an example of setting a user-adaptive battery charge range according to an embodiment of the present disclosure.

A processor 150 may analyze a battery usage pattern of a user based on battery usage history information. The processor 150 may determine a battery charge range (or a battery usage range) based on the analyzed battery usage pattern of the user and may determine a user-adaptive battery charge range based on the determined battery charge range. Referring to FIG. 4, the processor 150 may determine the battery charge range from a SOC of, for example, 20% to a SOC of 80% based on the battery usage pattern of the user. The processor 150 may determine a maximum amount of charge, the SOC of 80%, in the battery charge range as a maximum amount of charge (i.e., a USOC upper limit), a USOC of 100%, in the user-adaptive battery charge range. Furthermore, the processor 150 may determine a minimum amount of charge, the SOC of 20%, in the battery charge range as a minimum amount of charge (i.e., a USOC lower limit), a USOC of 0%, in the user-adaptive battery charge range.

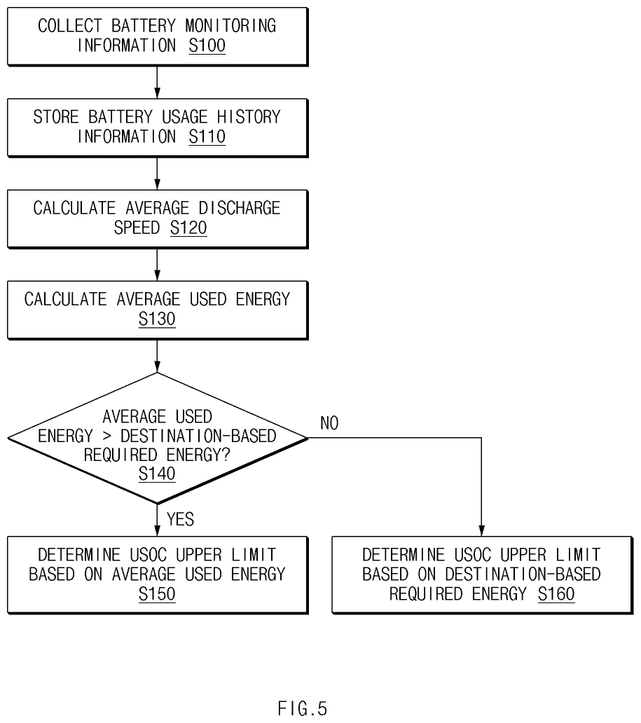

FIG. 5 is a flowchart illustrating a battery management method according to an embodiment of the present disclosure. The battery management method may be performed, at least partially, by the battery management apparatus 100 of FIG. 1, for example.

In an operation S100, the processor 150 may collect battery monitoring information using a data collector 130. The battery monitoring information may include battery state information, a battery SOC, a battery USOC, a charging start time, a charging end time, used energy, a charging start SOC, a charging end SOC, a charging start USOC, a charging end USOC, a usage time, and/or the like.

In an operation S110, the processor 150 may generate and store battery usage history information based on the battery monitoring information. The battery usage history information may include battery usage time information and battery energy usage information. The battery energy usage information may be information associated with cycle aging according to charging and discharging of the battery 120. Cycle aging may be a time (or a battery unused time) that may affect battery aging (or degradation) while the battery 120 is not in use. The battery energy usage information may include an amount of used energy obtained by accumulating energy used during charging or while driving for each predetermined SOC and temperature interval of the battery 120 (or accumulated battery used energy). The battery energy usage information may include an accumulated driving time and an average battery voltage.

In an operation S120, the processor 150 may calculate or otherwise determine an average discharge speed using the battery usage history information. The processor 150 may calculate or otherwise determine the average discharge speed of the battery 120 using accumulated used energy, an accumulated driving time, and an average battery voltage in the battery usage history information.

In an operation S130, the processor 150 may calculate or otherwise determine average used energy based on the battery usage history information. The average used energy may refer to an average amount of electric energy used up to next charging after charging. In other words, the average used energy may be defined as an average amount of electric energy used on one charge. The processor 150 may calculate or otherwise determine average used energy using the average discharge speed.

In an operation S140, the processor 150 may compare the average used energy with destination-based required energy. When a destination is set in a navigation device, the processor 150 may receive starting point information and destination information from the navigation device. The processor 150 may calculate or otherwise determine destination-based required energy, or energy required to reach the destination, with regard to a route from a starting point to the destination. The processor 150 may compare the average used energy with the destination-based required energy to determine whether the average used energy is greater than the destination-based required energy.

When it is determined that the average used energy is greater than the destination-based required energy, in an operation S150, the processor 150 may determine a USOC upper limit based on the average used energy. The processor 150 may add the average used energy to minimum remaining energy to determine the USOC upper limit.

When it is determined that the average used energy is not greater than the destination-based required energy, in an operation S160, the processor 150 may determine a USOC upper limit based on the destination-based required energy. The processor 150 may add the destination-based required energy to the minimum remaining energy to determine the USOC upper limit. When the average used energy and the destination-based required energy are the same as each other, the processor 150 may add the average used energy or the destination-based required energy to the minimum remaining energy to determine the USOC upper limit.

The processor 150 may control charging of the battery based on the USOC upper limit and the USOC lower limit. Thereafter, upon charging, the processor 150 may determine whether the battery SOC reaches the USOC upper limit. When it is determined that the battery SOC reaches the USOC upper limit, the processor 150 may output a notification indicating a USOC of 100% (or full charging) to an output device (not shown). Meanwhile, when it is determined that the battery SOC reaches a USOC lower limit, the processor 150 may output a notification indicating a USOC of 0% to the output device.

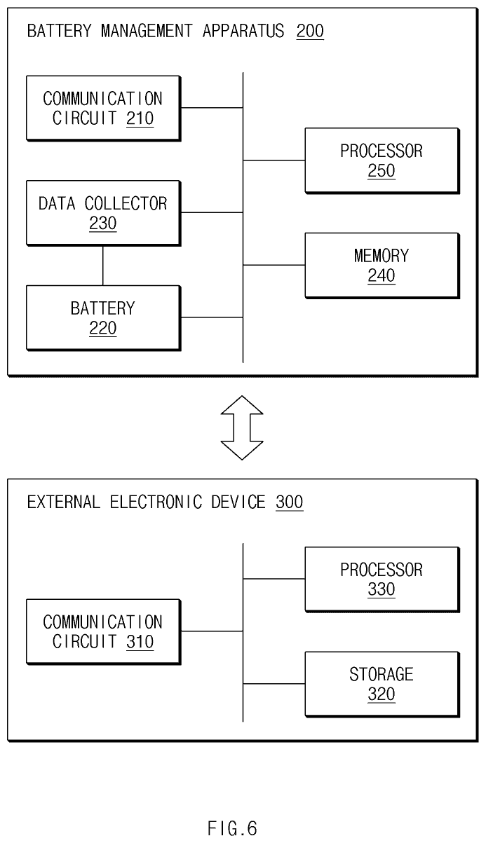

FIG. 6 is a block diagram illustrating a battery management apparatus according to another embodiment of the present disclosure.

A battery management apparatus 200 may be implemented inside or outside a vehicle. The battery management apparatus 200 may manage life, performance, and safety of a battery 220 in a cloud environment. Referring to FIG. 6, the battery management apparatus 200 may include a communication circuit 210, a data collector 230, a memory 240, a processor 250, and/or the like. The battery management apparatus 200 may also include, or may be coupled to, the battery 220. The components of the battery management apparatus 200 may correspond to components of a battery management apparatus 100 shown in FIG. 1. Hereinafter, a description duplicated with the description of the components of the battery management apparatus 100, shown in FIG. 1, may be omitted from the description of the components of the battery management apparatus 200.

The communication circuit 210 may support at least one of wired communication or wireless communication, or any combination thereof between the battery management apparatus 200 and an external device (e.g., an external electronic device 300 or the like).

The battery 220 may store electric energy. The battery 220 may supply electric energy to an electrical device loaded into the vehicle.

The data collector 230 may collect battery monitoring information using a sensor, an electronic device, and/or the like. The battery monitoring information may include battery state information, a battery SOC, a battery USOC, a charging start time, a charging end time, used energy, a charging start SOC, a charging end SOC, a charging start USOC, a charging end USOC, a usage time, and/or the like.

Instructions executed by the processor 250 may be stored in the memory 240. A measurement algorithm, a SOC computation algorithm, a SOH estimation algorithm, a cell balancing algorithm, a thermal management algorithm, a diagnostic algorithm, a protection algorithm, or any combination thereof. Battery information, charge/discharge control information, and/or the like may be stored in the memory 240.

The processor 250 may transmit the battery monitoring information collected by the data collector 230 to the external electronic device 300 via the communication circuit 210. The processor 250 may receive the result of analyzing a battery usage pattern of a user, that may be transmitted from the external electronic device 300, using the communication circuit 210. The result of analyzing the battery usage pattern of the user may include an average discharge speed and/or average used energy.

The processor 250 may determine a user-adaptive battery charge range based on the received result of analyzing the battery usage pattern of the user. The processor 250 may determine a USOC upper limit based on the average discharge speed and/or the average used energy in the result of analyzing the battery usage pattern of the user. The processor 250 may control charging of the battery 220 based on the determined user-adaptive battery charge range. For example, the processor 250 may, when the battery 220 is being charged, determine the battery 220 to be fully charged when the charge of the battery 220 reaches the USOC upper limit determined based on the average discharge speed and/or the average used energy.

When a destination is set in a navigation device (not shown), the processor 250 may receive predetermined starting point information and the set destination information from the navigation device. The processor 250 may calculate or otherwise determine destination-based required energy, or electric energy required to reach the destination with regard to a route from a predetermined starting point to the set destination. When calculating or otherwise determining the destination-based required energy, the processor 250 may use an average discharge speed.

The processor 250 may compare the average used energy with the destination-based required energy to determine whether the average used energy is greater than the destination-based required energy. When it is determined that the average used energy is greater than the destination-based required energy, the processor 250 may determine a USOC upper limit based on the average used energy. For example, the processor 250 may add the average used energy to minimum remaining energy to determine the USOC upper limit. When it is determined that the average used energy is not greater than the destination-based required energy, the processor 250 may determine a USOC upper limit based on the destination-based required energy. For example, the processor 250 may add the destination-based required energy to the minimum remaining energy to determine the USOC upper limit.

When the average used energy and the destination-based required energy are the same as each other, the processor 250 may add the average used energy or the destination-based required energy to the minimum remaining energy to determine the USOC upper limit.

The processor 250 may use the determined USOC upper limit as criteria for determining whether the battery 220 is fully charged. The processor 250 may determine whether the battery SOC reaches the determined USOC upper limit upon charging. When it is determined that the battery SOC reaches the USOC upper limit, the processor 250 may output a notification indicating that the battery charging is completed via an output device.

The external electronic device 300 may include a communication circuit 310, storage 320, a processor 330, and/or the like, which are connected with each other via a communication bus. A description duplicated with components corresponding to the components of the battery management apparatus 200 in the description of the components included in the external electronic device may be omitted.

The communication circuit 310 may enable the external electronic device 300 to perform communication with the battery management apparatus 200. The communication circuit 310 may receive the battery monitoring information transmitted from the battery management apparatus 200.

The storage 320 may provide a large-capacity storage function, such as a hard disk. The storage 320 may be implemented as various types of storage media, such as the memory 240 of the battery management apparatus 200. User information may be stored in the storage 320. The user information may include user identification information, unique information of a battery owned by a user, and/or unique information of a vehicle into which the battery is mounted.

The battery monitoring information received via the communication circuit 310 may be stored in the storage 320. Battery usage history information for each user based on the battery monitoring information may be stored in the storage 320. The battery usage history information for each user may include battery usage time information and battery energy usage information of a user who owns a vehicle loaded with the battery 220 managed by the battery management apparatus 200. The battery usage time information may be information associated calendar aging over time. As shown in FIG. 2, the battery usage time information may include a battery unused time accumulated for each predetermined SOC and temperature interval of the battery 220 (or an accumulated battery unused time). The battery energy usage information may be information associated with cycle aging according to charging and discharging of the battery 220. Referring to FIG. 3, the battery energy usage information may include an amount of used energy obtained by accumulating energy used during charging or while driving for each predetermined SOC and temperature interval of the battery 220 (or accumulated battery usage energy). The battery energy usage information may include an accumulated driving time and an average battery voltage.

The processor 330 may include a memory (not shown) inside or outside. Instructions executed by the processor 330 may be stored in the memory.

The processor 330 may receive the battery monitoring information transmitted from the battery management apparatus 200 via the communication circuit 310. The processor 330 may generate battery usage history information for each user based on the battery monitoring information. The processor 330 may store the generated battery usage history information for each user in the storage 320.

The processor 330 may analyze a battery usage pattern for each user based on the battery usage history information for each user, that is stored in the storage 320. The processor 330 may calculate or otherwise determine an average discharge speed for each user using the battery usage history information for each user. Furthermore, the processor 330 may calculate or otherwise determine average used energy for each user based on the battery usage history information for each user.

The processor 330 may transmit the result of analyzing a battery usage pattern for each user to the battery management apparatus 200 via the communication circuit 310. For example, the processor 330 may transmit the calculated or otherwise determined average discharge speed for each user and the calculated or otherwise determined average used energy for each user to the battery management apparatus 200. The processor 330 may select the result of analyzing the battery usage pattern to be transmitted to the battery management apparatus 200 from the result of analyzing the battery usage pattern for each user based on user information.

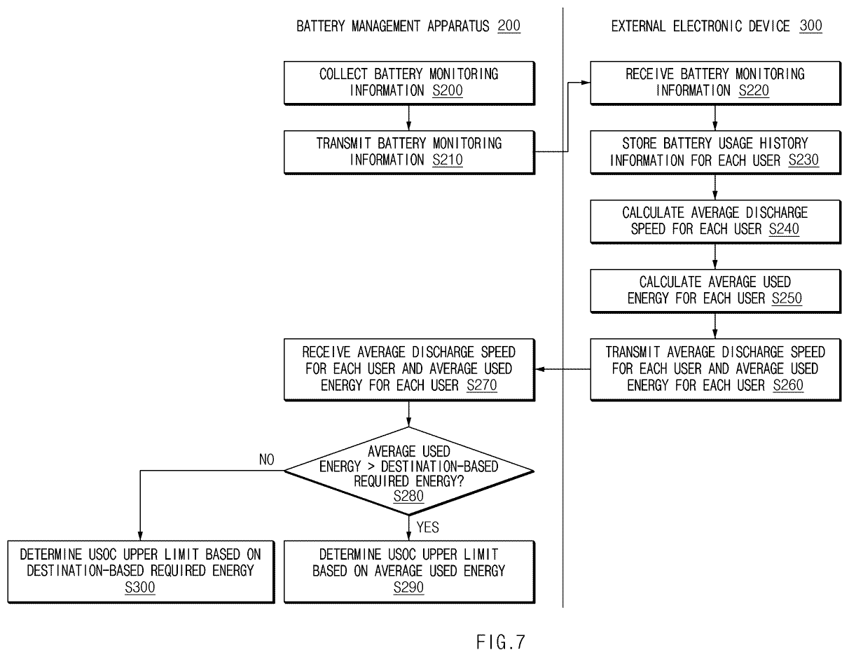

FIG. 7 is a flowchart illustrating a battery management method according to another embodiment of the present disclosure. The battery management method may be performed, at least partially, by the battery management apparatus 200 of FIG. 6, for example.

In an operation S200, the processor 250 of the battery management apparatus 200 may collect battery monitoring information using the data collector 230.

In an operation S210, the processor 250 of the battery management apparatus 200 may transmit the collected battery monitoring information to an external electronic device 300 via a communication circuit 210.

In an operation S220, a processor 330 of the external electronic device 300 may receive the battery monitoring information transmitted from the battery management apparatus 200 via a communication circuit 310. The processor 330 of the external electronic device 300 may receive battery monitoring information for the battery 220 managed by the battery management apparatus 200. The processor 330 may store battery monitoring information received for each user who owns the battery 220 managed by the battery management apparatus 200 in storage 320.

In an operation S230, the processor 330 of the external electronic device 300 may store battery usage history information for each user in the storage 320 based on the received battery monitoring information. The processor 330 may generate and store battery usage history information for each user based on the battery monitoring information received for each user. The battery usage history information for each user may include battery usage time information and battery energy usage information of a user who owns a vehicle loaded with the battery 220 managed by the battery management apparatus 200. The battery usage time information may include a battery unused time accumulated for each predetermined SOC and temperature interval of the battery 220. The battery energy usage information may include an amount of used energy obtained by accumulating energy used during charging or while driving for each predetermined SOC and temperature interval of the battery 220 (or accumulated battery usage energy). The battery energy usage information may include an accumulated driving time and an average battery voltage.

In an operation S240, the processor 330 of the external electronic device 300 may calculate or otherwise determine an average discharge speed for each user based on the battery usage history information for each user.

In an operation S250, the processor 330 of the external electronic device 300 may calculate or otherwise determine average used energy for each user based on the battery usage history information for each user. The processor 330 of the external electronic device 300 may calculate or otherwise determine average used energy for each user using the average discharge speed for each user and the accumulated driving time.

In an operation S260, the processor 330 of the external electronic device 300 may transmit the calculated or otherwise determined average discharge speed for each user and the calculated or otherwise determined average used energy for each user using the communication circuit 310.

In an operation S270, the processor 250 of the battery management apparatus 200 may receive the average discharge speed for each user and the average used energy for each user, that are transmitted from the external electronic device 300, via the communication circuit 210.

In an operation S280, the processor 250 of the battery management apparatus 200 may compare the average used energy with destination-based required energy to determine whether the average used energy is greater than the destination-based required energy. When a destination is set in a navigation device, the processor 250 of the battery management apparatus 200 may calculate or otherwise determine the destination-based required energy which is electric energy required to reach the set destination with regard to a route from a predetermined starting point to the set destination. When the destination is not set in the navigation device, the processor 250 of the battery management apparatus 200 may emit the process of comparing the average used energy with the destination-based required energy.

When it is determined that the average used energy is greater than the destination-based required energy, in an operation S290, the processor 250 may determine a USOC upper limit based on the average used energy. The processor 250 may add the average used energy to minimum remaining energy which is a USOC lower limit to determine the USOC upper limit.

When it is determined that the average used energy is not greater than the destination-based required energy, in an operation S300, the processor 250 may determine a USOC upper limit based on the destination-based required energy. The processor 250 may add the destination-based required energy to the USOC lower limit to determine the USOC upper limit.

Thereafter, upon charging, the processor 250 may determine whether the battery SOC reaches the USOC upper limit. When it is determined that the battery SOC reaches the USOC upper limit, the processor 250 may output a notification indicating a USOC of 100% to an output device. Meanwhile, when it is determined that the battery SOC reaches the USOC lower limit, the processor 250 may output a notification indicating a USOC of 0% to the output device.

The description is given of the example in which the battery management apparatus 200 compares the average used energy with the destination-based required energy to determine the USOC upper limit based on the compared result in the above embodiment, but the present disclosure is not limited thereto. The external electronic device 300 may be implemented to receive destination information set in the navigation device from the battery management apparatus 200 to calculate or otherwise determine destination-based required energy and compare the average used energy with the destination-based required energy to determine a USOC upper limit based on the compared result.

As described above, the battery management apparatus 100, 200 according to embodiments of the present disclosure may reduce the SOC upper limit for determining whether the charging of the battery is completed based on the battery usage pattern of the user, thus enabling extended battery life and increasing stability of the battery.

The battery management apparatus 100, 200 according to embodiments of the present disclosure may adjust the SOC upper limit with regard to a charge frequency compared to the battery usage pattern for each user. When the charge frequency compared to the battery usage pattern for a user increases, the battery management apparatus 100, 200 may reduce the SOC upper limit to optimize battery life.

The battery management apparatus 100, 200 according to embodiments of the present disclosure may provide a real-time life estimation result according to a battery charge pattern and/or a vehicle operation pattern to guide a user (or a driver) to change the battery usage pattern. The battery management apparatus 100, 200 may estimate battery life in real time using the SOH estimation algorithm.

Embodiments of the present disclosure may analyze a battery usage pattern of a user and may set a maximum amount of charge of a battery based on the analyzed battery usage pattern of the user, thus extending battery life and increasing battery safety.

Hereinabove, although the present disclosure has been described with reference to some embodiments and the accompanying drawings, the present disclosure is not limited thereto. Rather, the present disclosure may be variously modified or altered by those having ordinary skill in the art to which the present disclosure pertains without departing from the spirit and scope of the present disclosure claimed in the following claims. Therefore, the described embodiments of the present disclosure are not intended to limit the technical spirit of the present disclosure. Rather, the described embodiments are provided only for the illustrative purpose. The scope of the present disclosure should be construed on the basis of the accompanying claims, and all the technical ideas within the scope equivalent to the claims should be included in the scope of the present disclosure.

What is claimed is:

1. A battery management apparatus, comprising:
a memory; and
a processor,
wherein the processor is configured to:
store battery usage history information based on battery monitoring information of a battery in a vehicle,
determine a battery usage pattern based on the battery usage history information,
determine a user-adaptive battery charge range based on the battery usage pattern, and
control charging of the battery based on the user-adaptive battery charge range.

2. The battery management apparatus of claim 1, wherein the processor is configured to accumulate and store used energy for each predetermined remaining battery capacity and temperature interval based on the battery usage history information.

3. The battery management apparatus of claim 1, wherein the processor is configured to determine an average discharge speed based on the battery usage history information.

4. The battery management apparatus of claim 1, wherein the processor is configured to determine average used energy based on the battery usage history information.

5. The battery management apparatus of claim 4, wherein the processor is configured to determine destination-based energy required to reach a destination set in a navigation device, based on a route to the destination set in the navigation device.

6. The battery management apparatus of claim 5, wherein the processor is configured to:
compare the average used energy with the destination-based energy; and
determine a maximum amount of charge within the user-adaptive battery charge range by adding the average used energy to minimum remaining energy of the battery, based on determining that the average used energy is greater than the destination-based energy.

7. The battery management apparatus of claim 6, wherein the processor is configured to determine a maximum amount of charge within the user-adaptive battery charge range by adding the destination-based energy to the minimum remaining energy of the battery, based on determining that the average used energy is not greater than the destination-based energy.

8. The battery management apparatus of claim 1, wherein the processor is configured to transmit the battery monitoring information to an external electronic device using a communication circuit.

9. The battery management apparatus of claim 8, wherein the external electronic device is configured to:
generate and store battery usage history information associated with a user based on the battery monitoring information; and
analyze a battery usage pattern for the user based on the battery usage history information associated with the user.

10. The battery management apparatus of claim 9, wherein the processor is configured to:
receive the battery usage pattern for the user via the communication circuit; and
set the user-adaptive battery charge range based on the battery usage pattern received for the user via the communication circuit.

11. A battery management method, comprising:
storing battery usage history information based on battery monitoring information of a battery in a vehicle;
determining a battery usage pattern based on the battery usage history information; and
determining a user-adaptive battery charge range based on the battery usage pattern, and
controlling charging of the battery based on the user-adaptive battery charge range.

12. The battery management method of claim 11, wherein storing the battery usage history information includes accumulating and storing used energy for each predetermined remaining battery capacity and temperature interval based on the battery usage history information.

13. The battery management method of claim 11, wherein determining the battery usage pattern includes determining an average discharge speed based on the battery usage history information.

14. The battery management method of claim 11, wherein determining the battery usage pattern includes determining average used energy based on the battery usage history information.

15. The battery management method of claim 14, wherein determining the user-adaptive battery charge range includes:
determining destination-based energy required to reach a destination set in a navigation device, based on a route to the destination set in the navigation device; and
comparing the average used energy with the destination-based energy.

16. The battery management method of claim 15, wherein determining the user-adaptive battery charge range includes determining a maximum amount of charge within the user-adaptive battery charge range by adding the average used energy to minimum remaining energy of the battery, based on determining that the average used energy is greater than the destination-based energy.

17. The battery management method of claim 15, wherein determining the user-adaptive battery charge range includes determining a maximum amount of charge within the user-adaptive battery charge range by adding the destination-based energy to minimum remaining energy of the battery, based on determining that the average used energy is not greater than the destination-based energy.

18. The battery management method of claim 11, wherein storing the battery usage history information includes:
transmitting the battery monitoring information to an external electronic device using a communication circuit; and
generating and storing, by the external electronic device, battery usage history information associated with a user based on the battery monitoring information.

19. The battery management method of claim 18, wherein determining the battery usage pattern includes analyzing a battery usage pattern for the user based on the battery usage history information associated with the user.

20. The battery management method of claim 19, wherein the determining of the user-adaptive battery charge range includes:
receiving the battery usage pattern for the user from the external electronic device; and
setting the user-adaptive battery charge range based on the battery usage pattern received for the user from the external electronic device.
